(19) United States
(12) Patent Application Publication
(10) Pub. No.: US 2025/0301963 A1
(43) Pub. Date: Oct. 2, 2025

(54) SYSTEM AND METHOD FOR BIASING PAPER DISPLAY

(71) Applicant: FRESHCUT PAPER, LLC, Concord, MA (US)

(72) Inventors: Peter Hewitt, Concord, MA (US); Xinxhi Jiao, Quincy, MA (US); Caffrey Caleb Fielding, Somerville, MA (US); Jonathan Oliveira Aoun, Saugus, MA (US)

(21) Appl. No.: 18/621,834

(22) Filed: Mar. 29, 2024

(51) Int. Cl. A01G 9/02

(52) U.S. Cl. CPC A01G 9/026

(57) ABSTRACT

A paper arrangement having a plurality of layers including a first layer with a first end, mid-section, and second end and a second layer with a first end, mid-section, and second end, wherein the first end of the first layer is coupled to the first end of the second layer, and the second end of the first layer is coupled to the second end of the second layer; and a biasing element with a first end, mid-section, and second end, wherein the first end of the biasing element is coupled to the mid-section of the first layer, and the second end of the biasing element is coupled to the mid-section of the second layer, and the mid-section of the biasing element includes a fold to allow the mid-section to expand from a folded state to an unfolded state.

### BACKGROUND

### 1. Field of the Disclosure

At least one example in accordance with the present disclosure relates generally to decorative paper arrangements and displays, as well as methods and systems for assembling, storing and biasing said arrangements and displays.

### SUMMARY

According to at least one aspect of the present disclosure a three-dimensional flora paper arrangement is provided, comprising: a plurality of layers including a first layer with a first end, mid-section, and second end and a second layer with a first end, mid-section, and second end, wherein the first end of the first layer is coupled to the first end of the second layer, and the second end of the first layer is coupled to the second end of the second layer; and a biasing element with a first end, mid-section, and second end, wherein the first end of the biasing element is coupled to the mid-section of the first layer, and the second end of the biasing element is coupled to the mid-section of the second layer, and the mid-section of the biasing element includes a fold to allow the mid-section to expand from a folded state to an unfolded state.

In some examples, a portion of first layer or second layer is paper and shaped like a plant. In some examples, a portion of first layer or second layer is paper and shaped like a vase. In some examples, the first end of the biasing element is foldably coupled to the mid-section of the biasing element, and the second end of the biasing element is foldably coupled to the mid-section of the biasing element. In some examples, the mid-section of the biasing element is substantially circular in shape. In some examples, the first end and second end of the biasing element are substantially rectangular in shape. In some examples, the paper arrangement further comprises a third layer rotatably coupled to the first layer, wherein the third layer can be rotated relative to the first layer. In some examples, the first layer includes one or more slots, there third layer being coupled to the one or more slots and having a rotational range of motion limited by one or more dimensions of the one or more slots. In some examples, the paper arrangement further comprises a first fastener coupled to the first layer and a second fastener coupled to the second layer, the first fastener and second fastener being configured to selectively couple together. In some examples, the first layer includes a horizontal fold configured to allow an upper portion of the first layer to fold into a folded position adjacent to a lower portion of the first layer, and the first fastener is coupled to the upper portion of the first layer. In some examples, the biasing element includes an aperture configured to permit manipulation of the mid-section of the biasing element. In some examples, the paper arrangement further comprises a third layer coupled to and between the biasing element and the mid-section of the first layer and coupled to and between the biasing element and the mid-section of the second layer. In some examples, the third layer is a loop.

According to at least one aspect of the present disclosure, a method of biasing an arrangement into a three-dimensional display state is provided, the method comprising: coupling a first layer with a first end, mid-section, and second end, to a second layer with a first end, mid- section, and second end, wherein the first end of the first layer is coupled to the first end of the second layer, and the second end of the first layer is coupled to the second end of the second layer; and coupling a biasing element with a first end, foldable mid-section, and second end, to the first layer and second layer, wherein the first end of the biasing element is coupled to the mid-section of the first layer, and the second end of the biasing element is coupled to the mid-section of the second layer; and biasing the foldable mid-section of the biasing element from a folded state to an unfolded state or from an unfolded state to a folded state.

In some examples, the mid-section of the biasing element is foldably coupled to the first end of the biasing element and is foldably coupled to the second end of the biasing element. In some examples, biasing the foldable mid-section of the biasing element from an unfolded state to a folded state includes increasing a first angle between the mid-section and the first end of the biasing element, increasing a second angle between the mid-section and the second end of the biasing element, and increasing a third angle between a first portion of the mid-section and a second portion of the mid-section, wherein the third angle is approximately twice the first angle, and the first angle is approximately equal to the second angle. In some examples, the method further comprises coupling a first fastener to a second fastener, the first fastener coupled to the first layer and the second fastener coupled to the second layer. In some examples, the first layer includes a horizontal fold configured to allow an upper portion of the first layer to fold from a folded position adjacent to a lower portion of the first layer to an unfolded position, and the first fastener is coupled to the upper portion of the first layer, and the method further comprises: unfolding the first layer prior to coupling the first fastener to the second fastener.

According to at least one aspect of the present disclosure, a flora paper arrangement having a first state and a second state is provided, the arrangement comprising: a base having a first section and a second section; an upper portion coupled to the base; a biasing element having a fold configured to allow the biasing element to fold between the first state and the second state, a first end of the biasing element being coupled to a first central portion of the first section and a second end of the biasing element being coupled to a second central portion of the second section, the fold being situated orthogonal to a line between the first central portion and the second central portion.

In some examples, the first state is a folded state that is substantially flat, and the second state if an unfolded state that is substantially three-dimensional. In some examples, the arrangement is made of one or more types of paper product and the upper portion is configured to resemble a flower arrangement. In some examples, the biasing element has a first rectangular portion coupled to the first section of the base, a second rectangular portion coupled to the second section of the base, and a circular portion coupled between the first rectangular portion and the second rectangular portion, the fold being located on the circular portion. In some examples, the upper portion includes one or more rotatably coupled elements configured to rotate with respect to one another.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1A illustrates a paper arrangement according to an example;

FIG. 1B illustrates a paper arrangement according to an example;

FIG. 1C illustrates a paper arrangement according to an example;

FIG. 1D illustrates a paper arrangement according to an example;

FIG. 1E illustrates a paper arrangement according to an example;

FIG. 1F illustrates a paper arrangement according to an example;

FIG. 2 illustrates a comparison of an envelope and a paper arrangement according to an example;

FIG. 3A illustrate a paper arrangement according to an example;

FIG. 3B illustrate a paper arrangement according to an example;

FIG. 3C illustrate a paper arrangement according to an example;

FIG. 4A illustrates a biasing element according to an example;

FIG. 4B illustrates a biasing element according to an example;

FIG. 4C illustrates a biasing element according to an example;

FIG. 5A illustrates a paper arrangement according to an example;

FIG. 5B illustrates a paper arrangement according to an example;

FIG. 5C illustrates a paper arrangement according to an example;

FIG. 6 illustrates a paper arrangement according to an example;

FIG. 7A illustrates a paper arrangement according to an example;

FIG. 7B illustrates a paper arrangement according to an example;

FIG. 7C illustrates a paper arrangement according to an example; and

FIG. 8 illustrates one or more layers of a paper arrangement according to an example.

### DETAILED DESCRIPTION

Three-dimensional paper arrangements may be used decoratively to bring a desired effect to a room. Three-dimensional paper arrangements disclosed herein may be folded between a substantially two-dimensional storage state and a substantially three-dimensional display state.

Paper arrangements disclosed herein may be stored and shipped in the two-dimensional storage state, and then easily and readily “popped” open into the three-dimensional display state by a user upon arrival with minimal effort. In some examples, the arrangement of folds, order and placement of layers of the paper arrangements, and biasing mechanism used to retain the paper arrangement in the display state, may facilitate the efficient storage and minimal profile of the paper arrangement when it is in the storage state, as well as the transition from the storage state to the display state.

According to aspects and examples within this disclosure, the biasing element may be inelastic and relatively solid (such as cardstock or paper of heavier or stiffer characteristics than the paper used to construct the rest of the paper arrangement). As an inelastic biasing element, the biasing element may exert force in an outward direction from an inner point or innermost point of the paper arrangement, thereby biasing the paper arrangement into the display state. This is in contrast to, for example, an elastic biasing element which may pull layers of the paper arrangement inward, thereby biasing the paper arrangement into the display state.

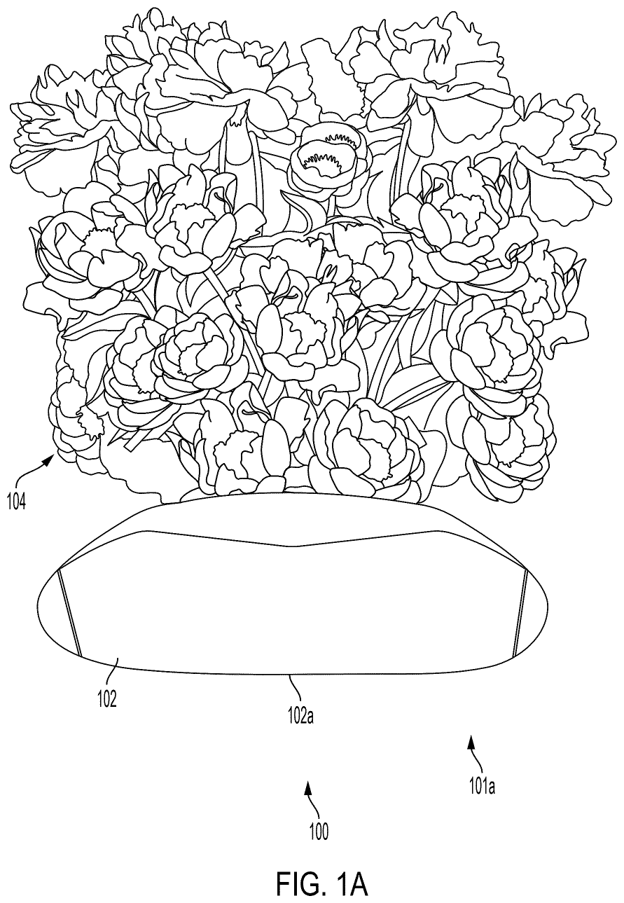

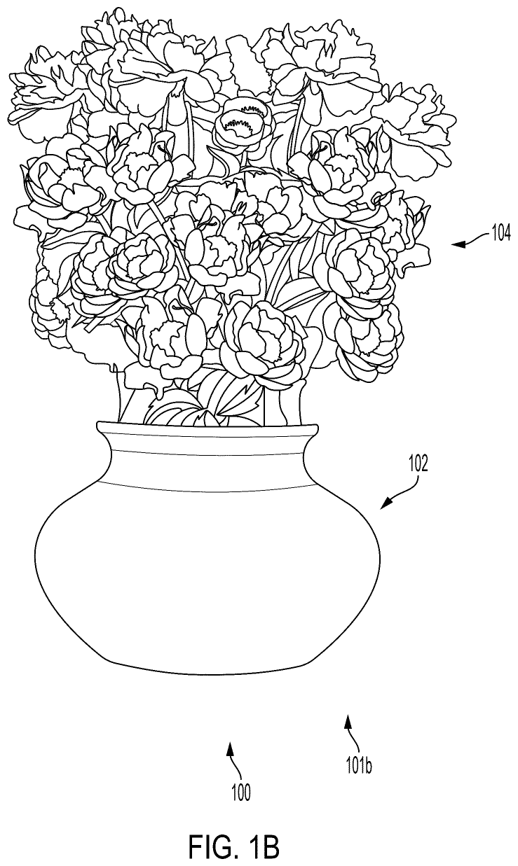

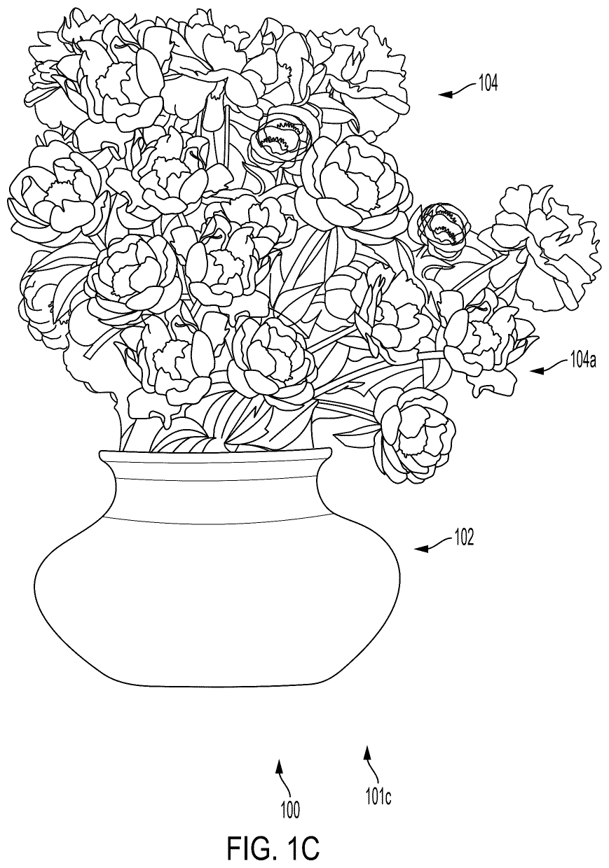

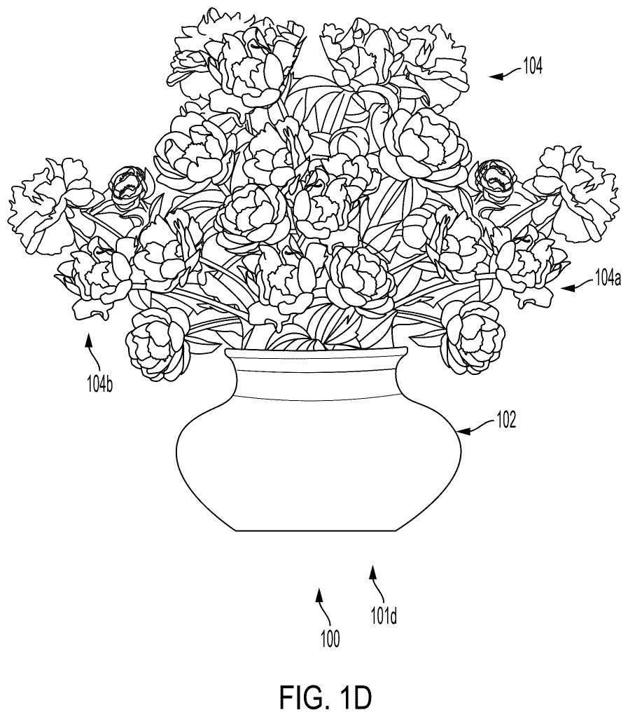

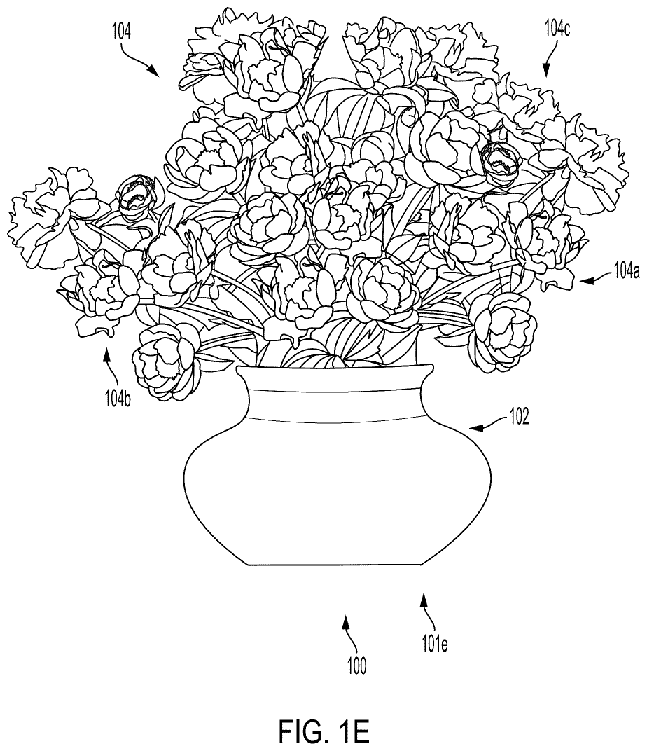

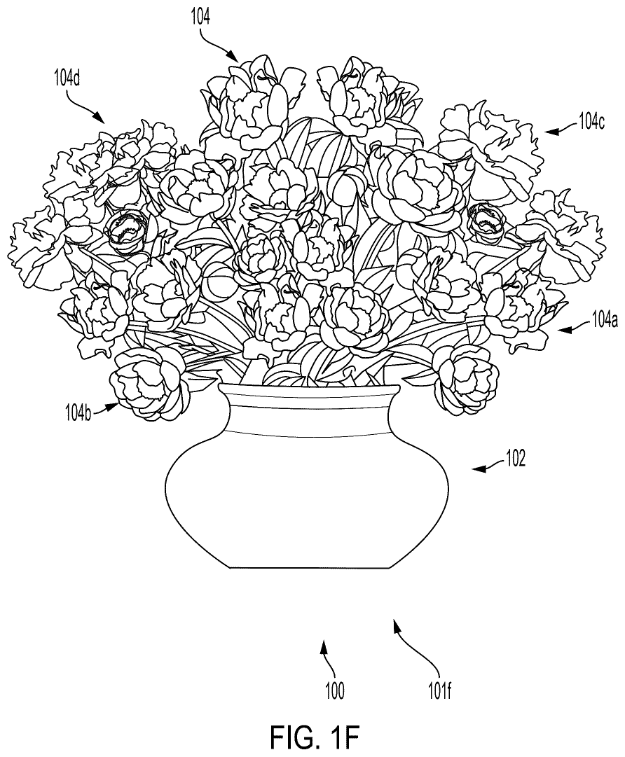

Because the biasing element exerts force outward from a center point, it may exert less force on a given point of the layers of the paper arrangement compared to an elastic biasing element, and may be simpler and easier to use by virtue of integration into the paper arrangement. In some examples, the biasing element may also facilitate a smaller total profile for the paper arrangement (when in the stored state) compared to an elastic biasing element. FIGS. 1A-IF illustrate a paper arrangement 100 in various states ranging from fully folded to unfolded according to examples.

FIG. 1A illustrates the paper arrangement 100 in a fully folded state 101a according to an example. The paper arrangement 100, when in the fully folded state 101a, has a smaller profile relative to intermediary states and the fully unfolded state. In the fully folded state 101a, the paper arrangement 100 has a base 102 and a plurality of layers 104 that may also be folded. The layers of the plurality of layers 104 may include folds (as will be discussed in greater detail later), allowing the layers of the plurality of layers 104 to overlap. The base 102 has been folded so as to occupy less space than the base 102 would occupy in the unfolded (or display) state. In some examples, the base 102 may include a fold 102a located in the center or in a central portion of the base 102.

FIG. 1B illustrates a paper arrangement 100 in a first intermediary state 101b (between being fully folded and fully unfolded) according to an example. In the first intermediary state 101b, the base 102 of the paper arrangement 100 has been unfolded and occupies a greater surface area relative to the fully folded state 101a. The plurality of layers 104 may remain unchanged and/or continue to have the same surface area as the plurality of layers 104 had in the fully folded state 101a.

FIG. 1C illustrates the paper arrangement 100 in a second intermediary state 101c according to an example. In this state, the base 102 may remain unchanged and/or continue to have the same surface area as in the first intermediary state 101b. The plurality of layers 104 may be adjusted such that a first portion 104a of a layer of the plurality of layers 104 has been unfolded and protrudes away from the longitudinal axis of the paper arrangement 100.

FIG. 1D illustrates the paper arrangement 100 in a third intermediary state 101d according to an example. In this state, the base 102 remains unchanged and/or continues to have the same surface area as in the first intermediary state 101b. The plurality of layers 104 may be adjusted such that a second portion 104b of a layer of the plurality of layers 104 has been unfolded and protrudes away from the longitudinal axis of the paper arrangement 104. The first portion 104a and second portion 104b may be of the same layer or may be of separate layers of the plurality of layers 104.

FIG. 1E illustrates the paper arrangement 100 in a fourth intermediary state 101e according to an example. In this state, the base 102 remains unchanged and/or continues to have the same surface area as in the first intermediary state 101b. The plurality of layers 104 may be adjusted such that a third portion 104c of a layer of the plurality of layers 104 has been unfolded and protrudes away from the longitudinal axis of the paper arrangement 104. The third portion 104c may be positioned further from the base 102 compared to the first portion 104a and the second portion 104b. The first portion 104a, second portion 104b, and third portion 104c may be of the same layer or may be of separate layers of the plurality of layers 104.

FIG. IF illustrates the paper arrangement 100 in a fully unfolded state 101f. In this state, the base 102 remains unchanged and/or continues to have substantially the same surface area as in the first intermediary state 101b. The plurality of layers 104 may be adjusted such that a fourth portion 104d of a layer of the plurality of layers 104 has been unfolded and protrudes away from the longitudinal axis of the paper arrangement 104. The fourth portion 104d may be positioned further from base 102 compared to the first portion 104a and the second portion 104b. The first portion 104a, second portion 104b, third portion 104c, and fourth portion 104d may be of the same layers or may be of separate layers of the plurality of layers 104.

In the foregoing examples of FIGS. 1A-IF, the various layers of the plurality of layers 104 (e.g., the first portion 104a, second portion 104b, third portion 104c, fourth portion 104d, and so forth) may be arranged such that some of the portions are layered in front of and/or behind other of the portions.

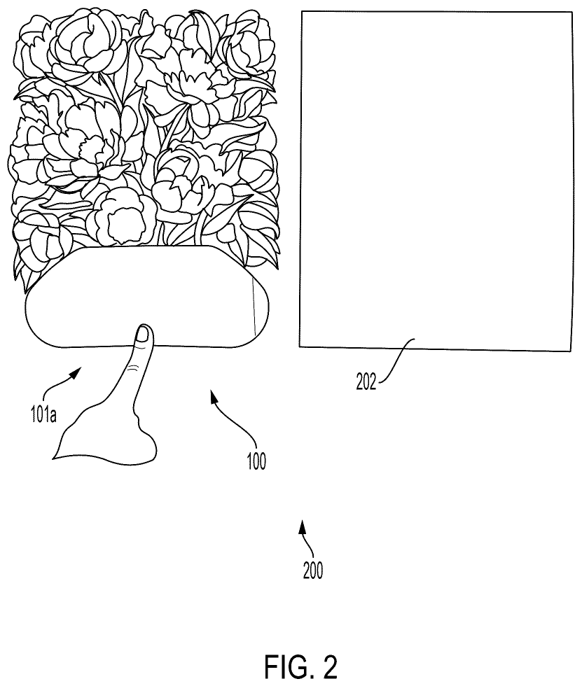

FIG. 2 illustrates a comparison 200 of an envelope 202 and the paper arrangement 100 in the fully folded state 101a according to an example.

In comparison 200, the paper arrangement 100 in the fully folded state 101a has a profile that fits entirely within the profile of the envelope 202, thus allowing the paper arrangement 100 to fit within the envelope 202 when in the fully folded state 101a, which may be convenient to transport and ship the paper arrangement 100.

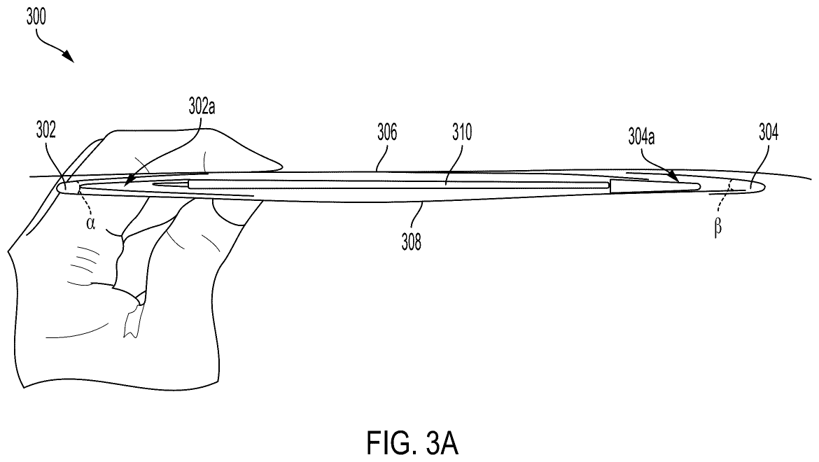

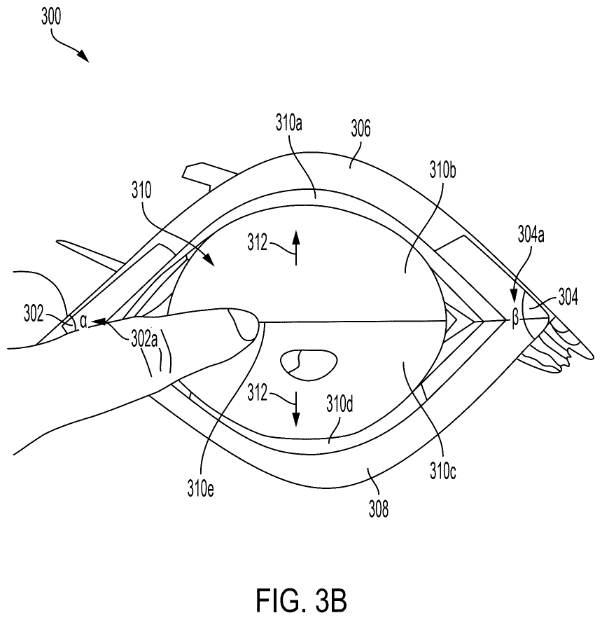

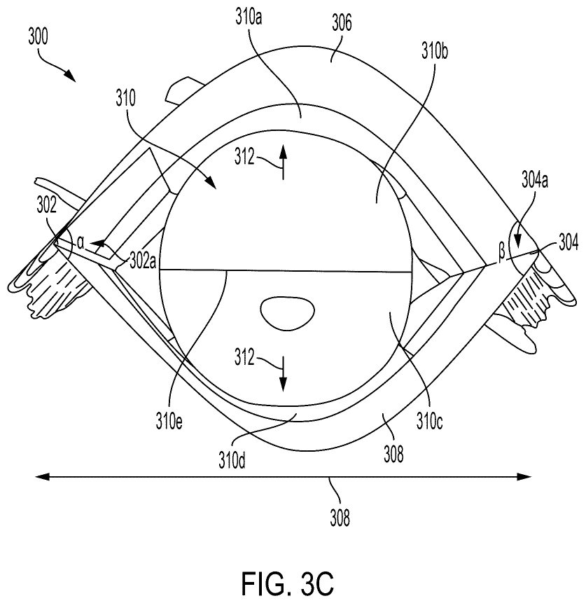

FIGS. 3A-3B illustrate a paper arrangement 300 from a “base” view according to various examples. From the base view, the internal workings of the biasing mechanism can be seen as the paper arrangement 300 is transitioned from the storage state to the display state. Note that the storage state may correspond to the fully folded state 101a of FIG. 1A, to any of the intermediary states of FIGS. 1B-1E, or to the fully unfolded state 101f of FIG. IF.

FIG. 3A illustrates the paper arrangement 300 from a view looking along a longitudinal axis of the paper arrangement 300 in the storage state according to an example. The paper arrangement 300 includes a first joint 302, a second joint 304, a first angle 302a, a second angle 304a, a first outer layer 306, a second outer layer 308, and one or more inner layers 310.

The first outer layer 306 is coupled to the second outer layer 308 at a first end via the first joint 302, and at second end via the second joint 304. The one or more inner layers 310 may be coupled to the first outer layer 306, the second outer layer 308, and/or one or more of the first joint 302 and second joint 304.

The first angle 302a is opposite the second angle 304a. In some examples the first angle 302a and second angle 304a may be equal or approximately equal, but in some examples the first angle 302a and second angle 304a may be non-equal. In the storage state, the first angle 302a and/or the second angle 304a may be relatively small (when each is measured as the smallest arc between the first outer layer 306 and the second outer layer 308 at the corresponding joint associated with that angle—e.g., the first joint 302 for the first angle 302a, and the second joint 304 for the second angle 304a). That is, the first angle 302a and/or second angle 304a may be zero, less than 5 degrees, less than 15 degrees, less than 30 degrees, and so forth. The first angle 302a and second angle 304a may be small enough that the first outer layer 306, second outer layer 308, and/or the one or more inner layers 310 may all overlap and lay relatively flat against one another (e.g., nearly parallel to one another).

In some examples, the innermost element of the inner elements 306 may be the biasing element 310 (illustrated in FIGS. 3B and 3C).

FIG. 3B illustrates the paper arrangement 300 from the same view as FIG. 3A, but the paper arrangement 300 is now partially deployed (e.g., between the storage state and the display state).

Portions of the one or more inner layers 310 are shown, including a first section 310a, a second section 310b, a third section 310c, a fourth section 310d, and a fold 310e.

The first section 310a is coupled between the first outer layer 306 and the second section 310b. The second section 310b may be coupled to the first section 310a along an intermediary portion of the first section 310a, such that the second section 310b is coupled to the first outer layer 306 via the first section 310a at one or more points in a region roughly halfway between the first joint 302 and the second joint 304.

The fourth section 310d is coupled between the second outer layer 308 and the third section 310a. The third section 310c may be coupled to the fourth section 310d along an intermediary portion of the fourth section 310d, such that the third section 310c is coupled to the second outer layer 308 via the fourth section 310d at one or more points in a region roughly halfway between the first joint 302 and the second joint 304.

In some examples, the first section 310a may be further coupled to the first joint 302 and second joint 304. In some examples, the fourth section 310d may be further coupled to the first joint 302 and second joint 304. The second section 302b is coupled to the third section 310c via the fold 310e.

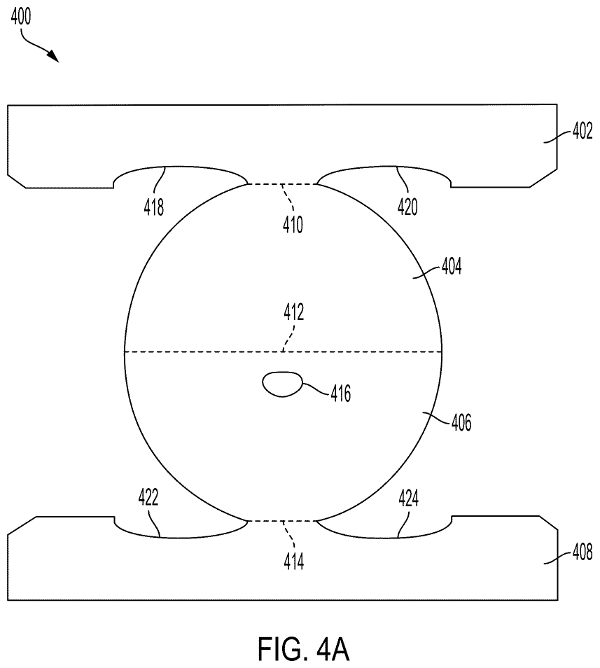

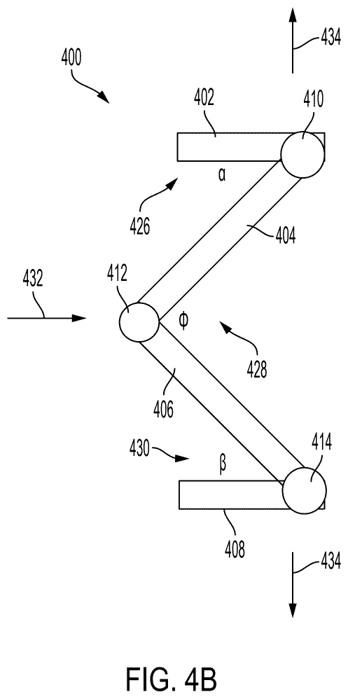

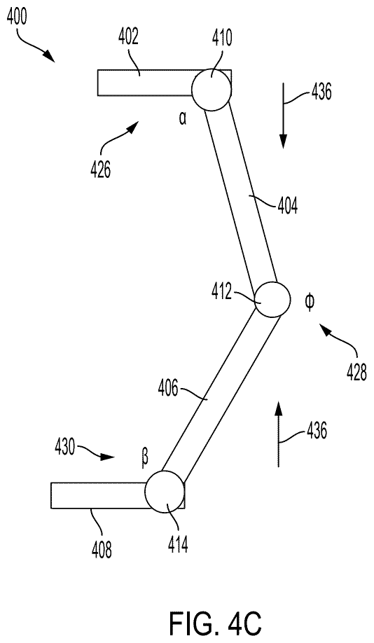

When a force is applied to the fold 310e, the angle between the second section 310b and third section 310c increases (as will be illustrated, with respect to an example, in FIG. 4B). The force applied to the fold 310e forces the second section 310b and third section 310c apart. This force is further transmitted through the first section 310a and/or fourth section 310d, forcing the first outer layer 306 and second outer layer 308 apart at an intermediary region between the first joint 302 and second joint 304, while the first outer layer 306 and second outer layer 308 remain coupled together at the first joint 302 and second joint 304. The force, labeled by trace 312 in the diagram, is an outward force with respect to an innermost layer or point in the paper arrangement 300 (that is, the force acts away from an innermost layer or point).

As a result of the outward force, the first angle 302a and/or second angle 304a may increase relative to their values in the storage state, but may be less than the angles in the display state.

FIG. 3C illustrates the paper arrangement 300 in the display state according to an example.

In the display state, the second section 310b and third section 310c have been placed in a state wherein an angle between the second section 310b and third section 310c has been maximized and is in an equilibrium state (so that the one or more inner layers 310 will not simply fold back into the storage state due to tension in the first outer layer 306 and second outer layer 308). This will be illustrated in greater detail with respect to FIG. 4B.

In the display state, the first angle 302a and/or second angle 304a may be at or near a respective maximum value (e.g., the angles between the first outer layer 306 and second outer layer 308 at the first joint 302 and/or second joint 304 may be at or near a maximum value, such as 75 degrees, 90 degrees, 180 degrees, and so forth).

In the display state, the fold 310e and/or the relationship between the second section 310b and third section 310c may be maintained due to friction. For example, an inward force (due to tension in the first outer layer 306 and/or second outer layer 308) may bias the second section 310b and third section 310c in a fixed position, as will be explained in greater detail with respect to FIGS. 4B-4C.

With respect to the foregoing, in some examples the first section 306 and second section 308 may be separate components (e.g., two pieces) or may be made from a single piece. In some examples, portions of the first section 306 may be made from the same piece as portions of the second section 308, but other portions of the first section 306 may be made from different pieces than any portion of the second section 308. Likewise, portions of the second section 308 may be made from the same piece as portions of the first section 306, but other portions of the second section 308 may be made from different pieces than any portion of the first section 306. As an example, a single piece of paper may wrap around more than half the perimeter of the base, and may thereby include one or more of the joints 302, 304. A second piece of paper may connect to either end of the first piece of paper, thereby completing the enclosed perimeter of the base. The second piece may not be part of one or both of the joints 302, 304. As a result, one section (e.g., the first section 306) may include components of the first piece of paper and the second piece of paper, while the other section (e.g., the second section 308) may include components of only the first piece of paper.

FIG. 4A illustrates a biasing element 400 according to an example. In some cases, the biasing element 400 may be an implementation of part or all of the one or more inner layers 310 of FIG. 3. For example, the first section 310a of FIGS. 3B-3C may correspond to a first section 402 of the biasing element 400, the second section 310b may correspond to a second section 404 of the biasing element 400, the third section 310c may correspond to a third section 406 of the biasing element 400, the fourth section 310d may correspond to a fourth section 408 of the biasing element 400, and the fold 310e may correspond to the second fold 412 of the biasing element 400.

The biasing element 400 includes a first section 402, a second section 404, a third section 406, a fourth section 408, a first fold 410, a second fold 412, a third fold 414, and a control element 416. The biasing element 400 may also include a first cutout 418, a second cutout 420, a third cutout 422, and/or a fourth cutout 424.

The first section 402 is coupled to the second section 404 via the first fold 410. The second section 404 is coupled to the third section 406 via the second fold 412. The third section 406 is coupled to the fourth section 408 via the third fold 414. The first cutout 418 is incorporated into the first section 402 on a first side of the first section 402 adjacent to the first fold 410. The second cutout 420 is incorporated into the first section 402 on a second side of the first section 402 adjacent to the first fold 410. The third cutout 422 is incorporated into the fourth section 408 on a first side of the fourth section 408 adjacent to the third fold 414. The fourth cutout 424 is incorporated into the fourth section 408 on a second side of the fourth section 408 adjacent to the third fold 414.

The first section 402 is configured to rotate around the longitudinal axis of the first fold 410. The second section 404 is configured to rotate around the longitudinal axis of the first fold 410, and the second section 404 is further configured to rotate around the longitudinal axis of the second fold 412. The third section 406 is configured to rotate around the longitudinal axis of the second fold 412, and the third section 406 is further configured to rotate around the longitudinal axis of the third fold 414. The fourth section 408 is configured to rotate around the longitudinal axis of the third fold 414. The particulars of the movement of the sections will be discussed in greater detail with respect to FIGS. 4B and 4C.

The control element 416 is configured to receive a manipulator (such as a digit of the hand). The user may use the control element 416 to change the position of the third section 406 and/or second section 404 relative to one another, even when the second section 404 and third section 406 are fully deployed in the display state.

FIG. 4B illustrates the biasing element 400 in a first position corresponding to the storage state and/or an intermediary state between the storage state and the display state according to an example. FIG. 4B adds a first angle 426 (α), a second angle 428 (ϕ), a third angle 430 (β), a first trace 432, and a second trace 434.

In the storage state, the first angle 426, second angle 428, and/or third angle 430 may be minimal (e.g., zero degrees, close to zero degrees, and so forth), such that the first section 402, second section 404, third section 406, and/or fourth section 408 may lay against one another and/or be parallel or approximately parallel to one another.

The user may apply a first force to the second section 404, third section 406, and/or the second fold 412 as indicated by the first trace 432. When force is applied in the direction of the first trace 432, an outward force indicated by the second trace 434 is applied to the biasing element 400. In some examples, the outward force indicated by the second trace 434 corresponds to the force indicated by the trace 312 of FIGS. 3A and 3B. As the first force is applied, the first angle 426, second angle 428, and/or third angle 430 may increase. The second angle 428 may, in some examples, be greater than the first angle 426 and/or third angle 430. The second angle 428 may, in some examples, increase at a faster rate than the first angle 426 and/or third angle 430. In some examples, the sum of the first angle 426 and second angle 430 may be equal to or approximately equal to the second angle 428.

FIG. 4C illustrates the biasing element 400 in the display state according to an example. FIG. 4C adds a third trace 436.

The third trace 436 indicates an inward force, for example, representing the inward force from tension in the first outer layer 308 and/or second outer layer 308 against the one or more inner layers 310 of FIGS. 3A-3C. The second joint 412 may be configured such that the second angle 428 has a maximum value beyond which the second angle 428 may not increase. As a result, the inward force indicated by the third trace 426 may not be sufficient to overcome the resistance of the second joint 412 to further motion in a direction that would increase the second angle 428. The relative position of the first section 402, second section 404, third section 406, and/or fourth section 408 may therefore be fixed with respect to each other in the display state (e.g., the first angle 426, second angle 428, and/or third angle 430 may be relatively constant in the display state).

However, a user may use the control mechanism 416 to decrease the second angle 428, thereby allowing the first section 402, second section 404, third section 406, and/or fourth section 408 to return to the storage state.

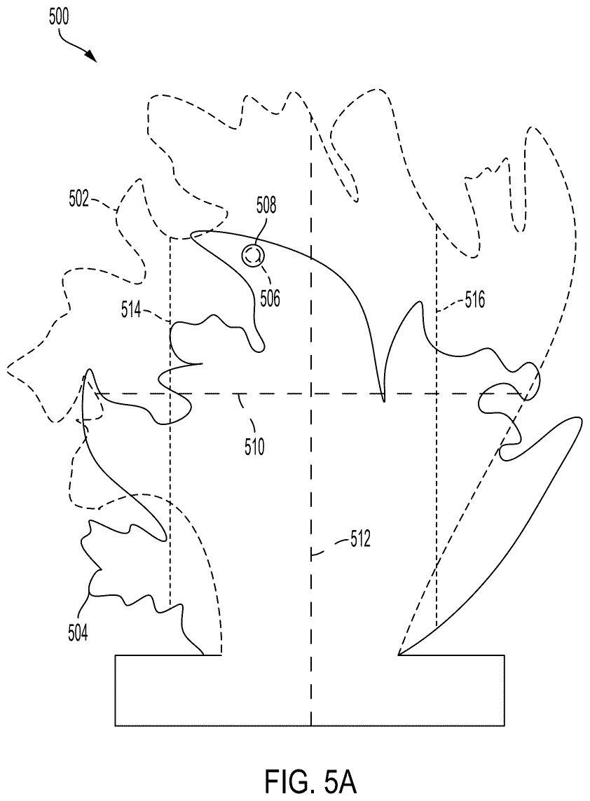

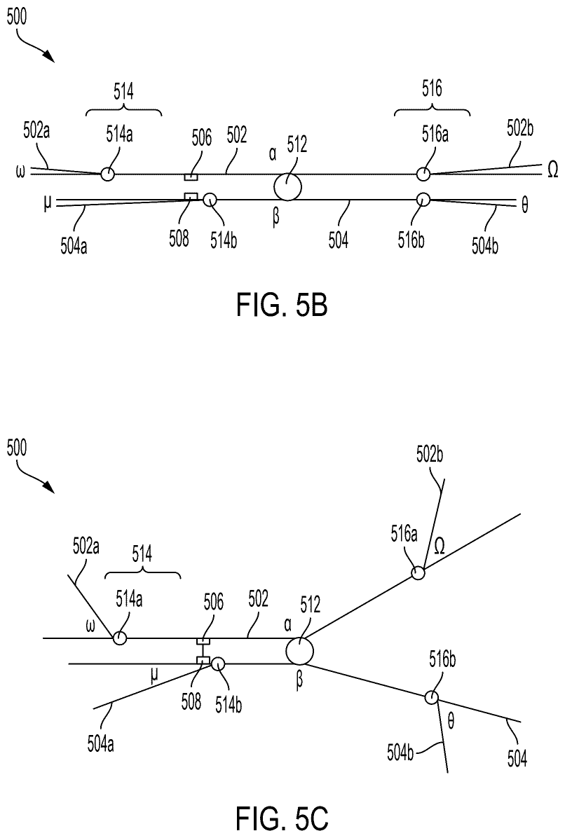

FIG. 5A illustrates a paper arrangement 500 according to an example. The paper arrangement 500 includes a first layer 502, a second layer 504, a first fastener 506, a second fastener 508, a horizontal fold 510, and a vertical fold 512. In FIG. 5, the fasteners enable the portion of the first layer 502 above the horizontal fold 510 to be fixed into an unfolded state, as will be explained in greater detail below. The paper arrangement 500 may also include a second vertical fold 514 and a third vertical fold 516, which will be discussed in greater detail with respect to FIG. 5B.

The first layer 502 may be coupled to the second layer 504 at multiple points. For example, the base of the first layer 502 may overlap with and/or be coupled to the base of the second layer 504. The first layer 502 and second layer 504 may also be coupled together via the first fastener 506 and second fastener 508. The first fastener 506 is coupled to the first layer 502. The second fastener 508 is coupled to the second layer 504. The first fastener 506 and second fastener 508 may be selectively coupled together. The horizontal fold 510 may be incorporated into the first layer 502. The vertical fold 512 may be incorporated into the first layer 502 and/or the second layer 504.

In some examples, the first layer 502 is an inner layer and the second layer 504 is an outer layer. Thus, in some examples, the first layer 502 may appear to be behind the second layer 504. The arrangement of the first layer 502 as an inner layer and the second layer 504 as an outer layer may provide three-dimensionality to the paper arrangement 500 when a biasing element (such as the biasing element 400 of FIGS. 4A-4C) biases the paper arrangement 500 into the display state.

The second layer 504 may have an inner face and an outer face. The outer face of the second layer 504 may be located on a side of the second layer 504 that does not face the first layer 502. The inner face of the second layer 504 may be located on a side of the second layer 504 that does face the first layer 502.

The first layer 502 may have an inner face and an outer face as well. The outer face of the first layer 502 may face the inner face of the second layer 504. The inner face of the first layer 502 may face the inner face of the first layer 502 (e.g., may face a center of the paper arrangement 500).

The first fastener 506 may be coupled to the outer face of the first layer 502. The second fastener 508 may be coupled to the inner face of the second layer 504. The first fastener 506 and second fastener 508 may be positioned on their respective first layer 502 and second layer 508 such that, when in the display state and/or a fully unfolded state, the first fastener 506 and second fastener 508 are located opposite one another.

The first layer 502 may fold along the longitudinal axis of the horizontal fold 510 and/or the vertical fold 512. In some examples, to keep at least the upper portion of the first layer 502 in place when unfolded (e.g., so that the upper portion does not overlap with the lower portion of the first layer 502 below the horizontal fold 510), the first fastener 506 may be fixed to the second fastener 508. Because the second layer 504 does not, in some examples, have a corresponding horizontal fold (or any horizontal fold), the second layer 504 may be unable to fold along the longitudinal axis of the horizontal fold 510. Some portions of the second layer 504 may be positioned above the horizontal fold 510 of the first layer 502. As a result, when the first fastener 506 and second fastener 508 are coupled together, the upper portion of the first layer 502 may be prevented from folding along the horizontal fold 510.

The first layer 502 and second layer 504 may also be folded with respect to the vertical axis 512. In some examples, the portions of the first layer 502 and/or second layer 504 on either side of the vertical axis 512 may have a 360-degree range of motion limited by the first fastener 506 and second fastener 508, and the coupling of the respective bases of the first layer 502 and/or second layer 504 to one another and/or to a biasing element or other layers (either inner or outer).

In some examples, the first fastener 506 and second fastener 508 may be hook-and-loop fasteners, adhesive fasteners, physical fasteners (such as snap buttons), and so forth. In some examples, the second layer 504 may overlap the horizontal fold 510 such that the horizontal fold 510 of the first layer 502 is not visible or is generally obscured from an outside frame-of-reference.

FIG. 5B illustrates the paper arrangement 500 from a top-down perspective according to an example. Elements are not necessarily shown to scale. Accordingly, in some examples, the perspective of FIG. 5B is orthogonal to the perspective of FIG. 5A. In FIG. 5B, the paper arrangement 500 is in a substantially flat state where the components are fully deployed but not yet shifted into a three-dimensional state, for example, as illustrated with respect to FIG. IF.

The paper arrangement 500 further includes a first-layer-second-vertical fold 514a (“first fold 514a”), a first-layer-third-vertical fold 516a (“second fold 516a”), a second-layer-second-vertical fold 514b (“third fold 514b”), and a second-layer-third-vertical fold 516b (“fourth fold 516b”). These folds correspond to the second vertical fold 514 and third vertical fold 516 of FIG. 5. The paper arrangement 500 further includes a first-layer-first-sublayer 502a (“first sublayer 502a”), a first-layer-second-sublayer 502b (“second sublayer 502b”), a second-layer-first-sublayer 504a (“third sublayer 504a”), and a second-layer-second-sublayer 504b (“fourth sublayer 504b”). Several angles are also shown, including α, β, ⊖, Ω, μ, and ω.

The first layer 502 and second layer 504 are coupled to one another at one “r more points, and may be coupled together at the vertical fold 512, or may have respective vertical folds 512. In some examples, the first layer 502 and second layer 504 are coupled together via a base (not pictured). The first sublayer 502a is coupled to the first layer 502 at the first fold 514a. The second sublayer 502b is coupled to the first layer 502 at the second fold 516a. The third sublayer 504a is coupled to the second layer 504 at the third fold 514b. The fourth sublayer 504b is coupled to the second layer 504 at the fourth fold 516b. As illustrated, the first fastener 506 and second fastener 508 are situated on their respective layers opposite one another so that they can be fastened together. Note that the first fold 514a, second fold 516a may be situated anywhere along the first layer 502, and the third fold 514b, and fourth fold 516b may be situated anywhere along the second layer 504, and the relative position of the folds 514a, 514b, 516a, 516b and fasteners 506, 508 along the first layer 502 and/or second layer 504 may be different than that which has been illustrated.

In FIG. 5B, the paper arrangement 500 is substantially flat. As a result, the angles α (the angle between the portions of the first layer 502 on either side of the vertical axis 512) and β (the angle between the portions of the second layer 504 on either side of the vertical axis 512) may be relatively large (e.g., 180 degrees, 170 degrees, 190 degrees, and so forth). The angles ⊖ (the angle between the fourth sublayer 504b and the second layer 504), Ω (the angle between the second sublayer 502b and the first layer 502), μ (the angle between the third sublayer 504a and the second layer 504), and ω (the angle between the first sublayer 502a and the second layer 502) may be relatively small (e.g., 0 degrees, 1 degree, 5 degrees, and so forth). The fasteners 506, 508 may be joined together or not.

The first sublayer 502a is a portion of the first layer 502 that is configured to fold away from the primary plane of the first layer 502 when in the display state. That is, the angle ω may increase (e.g., to 90 degrees, 135 degrees, 45 degrees, and so forth) when the paper arrangement 500 is placed in the display state. The second sublayer 502b is a portion of the first layer 502 that is configured to fold away from the primary plane of the first layer 502 when in the display state. That is, the angle Ω may increase (e.g., to 90 degrees, 135 degrees, 45 degrees, and so forth) when the paper arrangement 500 is placed in the display state.

The third sublayer 504a is a portion of the second layer 504 that is configured to fold away from the primary plane of the second layer 504 when in the display state. That is, the angle μ may increase (e.g., to 45 degrees, 90 degrees, 135 degrees, and so forth) when the paper arrangement 500 is placed in the display state. The fourth sublayer 504b is a portion of the second layer 504 that is configured to fold away from the primary plane of the second layer 504 when in the display state. That is, the angle ⊖ may increase (e.g., to 90 degrees, 135 degrees, 45 degrees, and so forth) when the paper arrangement 500 is placed in the display state.

FIG. 5C illustrates the paper arrangement 500 from the same perspective as FIG. 5B with the paper arrangement 500 in the display state (e.g., substantially unfolded) according to an example. In the display state, the various layers and sublayers are unfolded such that the footprint of the paper arrangement 500 has been increased compared to that of a folded state (such as the substantially flat state of FIG. 5B).

In the display state, the first fastener 506 and second fastener 508 may be fixed together (e.g., selectively coupled together). The first sublayer 502a may be unfolded away from the first layer 502, such that the angle ω may be large compared to the folded state (e.g., the angle ω may be 90 degrees, 135 degrees, 45 degrees, and so forth). The first fold 514a may be designed to retain the first sublayer 502a in the unfolded position. Likewise, the second sublayer 502b may be unfolded away from the first layer 502 such that the angle Ω may be large compared to the folded state (e.g., the angle Ω may be 90 degrees, 135 degrees, 45 degrees, and so forth). The second fold 516a may be designed to retain the second sublayer 502b in the unfolded position.

The first layer 502 may also be unfolded along the vertical axis 512, such that the angle α may be relatively smaller than in the folded state (e.g., 135 degrees, 90 degrees, 45 degrees, and so forth).

The third sublayer 502b may be unfolded away from the second layer 504, such that the angle μ may be large compared to the folded state (e.g., the angle μ may be 90 degrees, 135 degrees, 45 degrees, and so forth). The third fold 514b may be designed to retain the third sublayer 504a in the unfolded position. Likewise, the fourth sublayer 504b may be unfolded away from the second layer 504 such that the angle ⊖ may be large compared to the folded state (e.g., the angle β may be 90 degrees, 135 degrees, 45 degrees, and so forth). The fourth fold 516b may be designed to retain the fourth sublayer 504b in the unfolded position. The second layer 504 may also be unfolded along the vertical axis 512, such that the angle β may be relatively smaller than in the folded state (e.g., 135 degrees, 90 degrees, 45 degrees, and so forth).

In examples comprising more layers (e.g., third layers, fourth layers, and various additional sublayers), those layers and/or sublayers may also be folded or unfolded as described above with respect to FIGS. 5A-5C such that the footprint of the paper arrangement 500 may be increased, and various unfolded layers may provide an increased sense of three-dimensionality to a viewer.

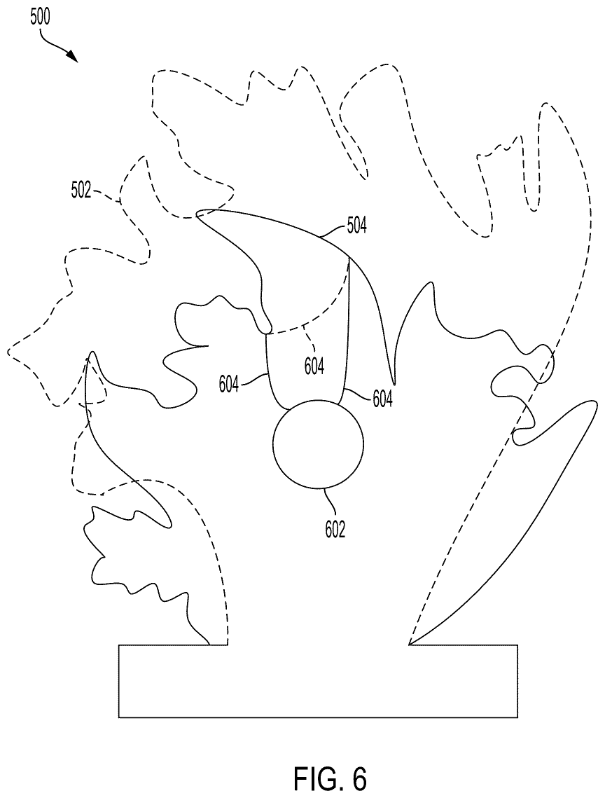

FIG. 6 illustrates the paper arrangement 500 of FIG. 5A from the same perspective as in FIG. 5A according to an example. FIG. 6 further includes one or more accessory items 602 (“ accessory item 602”) and one or more coupling mechanisms 604 (“coupling mechanism 604”).

The accessory item 602 may be any type of item designed to further accentuate the display. For example, the accessory item may related to a season or holiday, like a rendition of a Christmas ornament or a rendition of Fourth of July fireworks. The accessory item 602 may also be functional in some regard (e.g., by generating a light or sound, and so forth). The accessory item 602 may be made from paper or another substance, and may be coupled to the paper arrangement 500 via a coupling mechanism 604.

The coupling mechanism 604 may be designed to allow the easy removal and/or exchange of the accessory item 602 with another accessory item 602. As illustrated, the coupling mechanism 604 is a string wrapped around a portion of the second layer 504, with the dotted portion of the string indicating the portion of the coupling mechanism 604 between the second layer 504 and first layer 502. However, the coupling mechanism 604 may be other things as well, for example, hooks, tabs, adhesives, slots (for friction fits), and so forth.

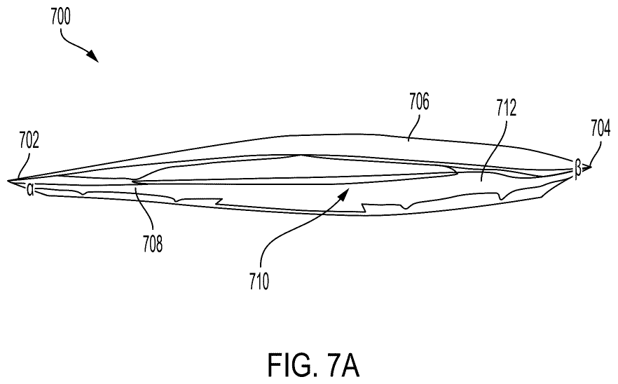

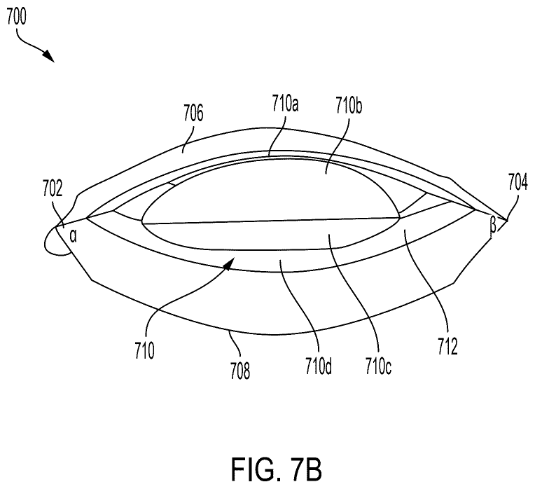

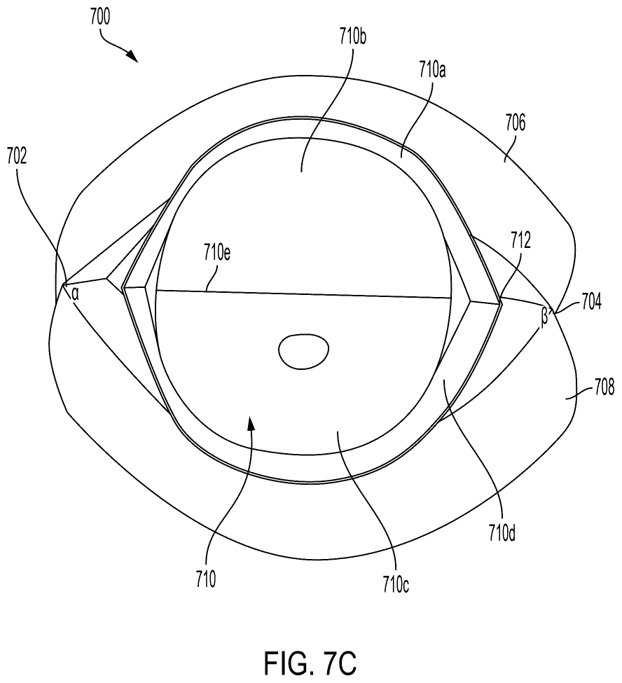

FIGS. 7A-7C illustrate a paper arrangement 700 according to an example. FIG. 7A shows the paper arrangement 700 in the storage state, FIG. 7B shows the paper arrangement 700 in an intermediary position between the storage and display states, and FIG. 7C shows the paper arrangement 700 in the display state, each according to an example.

FIGS. 7A-7C are similar to FIGS. 3A-3C in that FIGS. 7A-7C illustrates how a biasing mechanism (composed of the inner layers 710 and middle layer 712) biases the paper arrangement 700 into a display position. One difference between FIGS. 7A-7C and FIGS. 3A-3C is that the paper arrangement 700 has a different biasing mechanism coupled to the outer layers 706, 708 in a different way compared to that of FIGS. 3A-3C.

The paper arrangement 700 includes a first joint 702, a second joint 704, a first outer layer 706, a second outer layer 708, and one or more inner layers 710 including a first section 710a, a second section 710b, a third section 710c, a fourth section 710d, a fold 710e, and a middle layer 712.

FIG. 7A illustrates the paper arrangement 700 in the storage state according to an example. In the storage state, the angles, α and β, between the first outer layer 708 and the second outer layer 708, are relatively small. That is, α and/or β may be zero degrees, or some other relatively small value (e.g., less than 20 degrees, less than 15 degrees, less than 10 degrees, less than 5 degrees, and so forth).

In the storage state, the various layers 706, 708, 710, 712 lay flush against one another. That is, the various layers 706, 708, 710, 712 may lay flat or approximately flat against one another, thereby minimizing the volume of the paper arrangement 700.

FIG. 7B illustrates the paper arrangement 700 in an intermediate position according to an example. In the intermediate position, the angles, α and β, may be relatively larger compared to the storage position (e.g., as illustrated in FIG. 7A). For example, β and/or β may be greater than 15 degrees, greater than 30 degrees, greater than 90 degrees, and so forth. For example, α and/or β may be less than the angles in the display state (e.g., as illustrated in FIG. 7C), for example, less than 75 degrees, less than 90 degrees, less than 180 degrees, and so forth.

In some intermediate positions, between the storage and display states, the middle layer 712 may be relatively flush against the first outer layer 706 and/or second outer layer 708. As FIG. 7C illustrates, in the display state the middle layer 712 may not be flush with the outer layers 706, 708. To fit within the outer layers 706, 708, the middle layer 712 may have an outer circumference that is equal to or less than the inner circumference of the outer layers 706, 708, thus allowing the middle layer 712 to fold snuggly within the outer layers 706, 708. However, the middle layer 712 may not be coupled to portions of the outer layers 706, 708 near the joints 702, 704, as is illustrated in FIG. 7C. Thus, as the paper arrangement 700 transitions from the storage state, through various intermediate positions, to the display state, the overlapping or contacting area of the surfaces of the middle layer 712 and outer layers 706, 708 may decrease.

FIG. 7C illustrates the paper arrangement 700 in the display state according to an example. In the display state, the angles, α and/or β, may be at a maximum value. For example, the angles α and/or β may be 75 degrees or more, 90 degrees or more, 180 degrees or more, and so forth, depending on the particular topology of the paper arrangement 700.

The first outer layer 706 is coupled to the second outer layer 708 in two places, the first joint 702 and the second joint 704. The first outer layer 706 is coupled to the middle layer 712 (for example, a middle section of the first outer layer 706, between the first joint 702 and second joint 704, may be coupled to the middle layer 712). The middle layer 712 is coupled to the first section 710a. The first section is coupled to the second section 710b. The second section 710b is coupled to the third section 710c via the fold 710e. The third section 710c is coupled to the fourth section 710d. The fourth section 710d is coupled to the middle layer 712. The middle layer 712 is coupled to the second outer layer 708 (for example, a middle section of the second outer layer 708, between the first joint 702 and second joint 704, may be coupled to the middle layer 712).

The outer layers 706, 708 may be the outer layers of the paper arrangement 700 and may be similar in form and/or function to other outer layers, for example, the outer layers 306, 308 of FIGS. 3A-3C.

The various sections 710a-710d and the fold 710e may be inner layers of the paper arrangement 700 and may be similar to the corresponding sections 310a-310d and fold 310e of FIGS. 3A-3C. However, unlike the sections 310a-310d and fold 310e of FIGS. 3A-3C, the sections 710a-710d are not necessarily coupled to the outer layers 706, 708. Instead, the middle layer 712 acts as an intermediary component that joins the outer layers 706, 708 to the first section 710a or fourth section 710d, respectively.

The middle layer 712 may include one or more component layers and need not be limited to a single layer. The middle layer 712 may correspond to a circumference of the inner layers 710 when the inner layers 710 are in the display state. In comparison to FIGS. 3A-3C, the middle layer 712 and the inner layers 710a-d are not necessarily coupled to multiple points of the each of the respective outer layers 706, 708. For example, in FIGS. 3A-3C, the first section 310a is coupled to the first outer layer 306 at points near the first joint 302 and second joint 304, as well as at various points between the first joint 302 and second joint 304. Likewise, the fourth section 310d is coupled to the second outer layer 308 at points near the first joint 302 and second joint 304 as well as at various points between said joints 302, 304. However, in some examples, the middle layer 712 is not coupled to the first outer layer 706 or second outer layer 708 near either of the joints 702, 704, and instead curves inward, relative to the joints 702, 704, to form a circle or generally circular shape. That is, as stated above, the middle layer 712 may be generally circular, describing a circumference of the biasing mechanism when the biasing mechanism (e.g., the inner layers 710a-d and the fold 710e) are in the display state. In some examples, the middle layer 712 may be coupled to the first outer layer 706 at only a single point in or at a median position between the joints 702, 704, or to a region (e.g., a plurality of points) in or at said median position. Likewise, the middle layer 712 may be coupled to the second outer layer 708 at only a single point in or at a median position between the joints 702, 704, or to a region (e.g., a plurality of points) in or at said median position. Thus, the edges of the middle layer 712 may not be in contact with the joints 702, 704 or regions of the outer layers 706, 708 near the joints 702, 704.

The middle layer 712 may be configured to bias the paper arrangement 700 into the storage state. The sections 710a-710d may be configured to bias the paper arrangement 700 into the display state. Thus, the sections 710a-710d may be engaged to bias the middle layer 712 into an expanded, substantially three-dimensional state where the middle layer 712 approximately describes the circumference of the inner layers 710 (e.g., while in the display state).

In the storage state, the middle layer 710, outer layers 706, 708, and inner layers 710 may all be substantially flat against one another, thereby minimizing the three-dimensional volume of the paper arrangement 700.

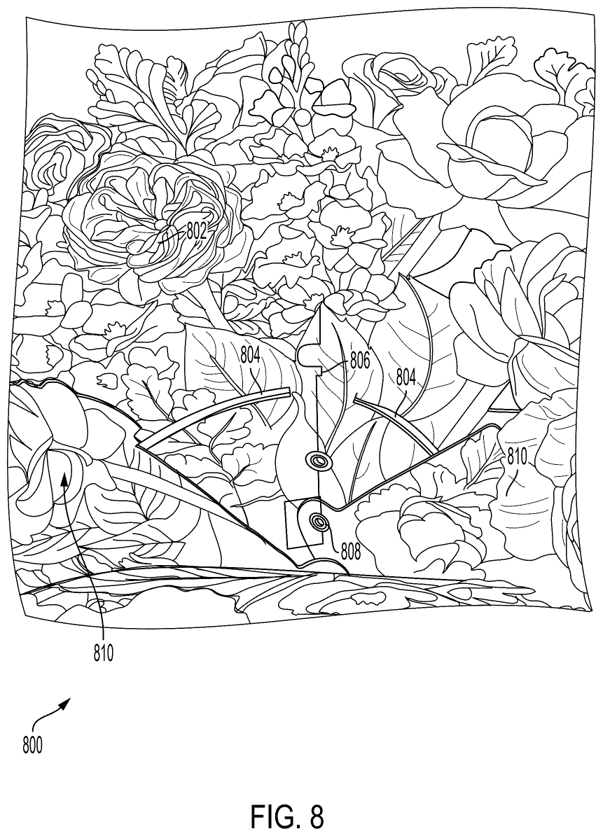

FIG. 8 illustrates a plurality of layers 800 of a paper arrangement (e.g., paper arrangement 100 of FIG. 1A, paper arrangement 300 of FIG. 3A, paper arrangement 700 of FIG. 7A, and so forth) according to an example. The plurality of layers 800 include one or more slotted layers 802 (“slotted layers 802”), and one or more mobile layers 810 (“mobile layers 810”). The plurality of layers may also include one or more fasteners 808 (“fasteners 808”, one or more folds 806 (“folds 806”), and one or more slots 804 (“slots 804”).

The slots 804 may be incorporated into the slotted layers 802. Likewise, the slotted layers 802 may include the folds 806, thereby allowing the slotted layers 802 to be folded into a storage state or unfolded into a display state. The fasteners 808 (which may be bolts, pins, hooks, or any other type of fixing mechanism) may couple the mobile layers 810 to the slotted layers 802. In some examples, the fasteners 808 rotatably coupled the mobile layers 810 to the slotted layers 802 so that the mobile layers 810 may pivot with respect to the fasteners 808 in a manner that is limited by the slots 804, as will be described in greater detail below.

The mobile layers 810 may be coupled to the slotted layers 802 via the fasteners 808 (as described above) as well as via the slots 804 (e.g., via a friction fit, adhesive, and so forth). In some examples, a portion of a respective layer of the mobile layers 810 may be placed within a given slot of the slots 804, such that the slot 804 effectively holds and/or retains that portion of the mobile layer, thereby limiting the motion of the mobile layer to a predetermined range corresponding to the shape of the slot.

For example, mobile layers 810 may slide from one end of the slots 804 to another while rotating with respect to the center of rotation defined by the fasteners 808. The motion of the mobile layers 810 may therefore be relative with respect to the particular slot of the slots 804 to which the given mobile layer is coupled.

The mobile layers 810 may be set to any position permitted by the range of motion provided by the slots 804, and need not be limited to only the ends of the slots 804. As a result, the mobile layers 810 may be set to any positioned desired by the user, thus allowing the user to control the volume and appearance of the associated paper arrangement and/or the layers 802, 810.

In FIG. 8, as an example, the mobile layers 810 may pivot, while remaining flush or approximately flush with the slotted layers 802, from positions that are on average further from the folds 806 to positions that are on average closer to the folds 806, thereby reducing the area and/or volume of the layers 802, 810 and allowing for the efficient storage of the corresponding paper arrangement.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A three-dimensional flora paper arrangement comprising:
a plurality of layers including
a first layer with a first end, mid-section, and second end and
a second layer with a first end, mid-section, and second end, wherein the first end of the first layer is coupled to the first end of the second layer, and the second end of the first layer is coupled to the second end of the second layer; and
a biasing element with a first end, mid-section, and second end, wherein the first end of the biasing element is coupled to the mid-section of the first layer, and the second end of the biasing element is coupled to the mid-section of the second layer, and the mid-section of the biasing element includes a fold to allow the mid-section to expand from a folded state to an unfolded state.

2. The three-dimensional flora paper arrangement of claim 1, wherein a portion of first layer or second layer is paper and shaped like a plant.

3. The three-dimensional flora paper arrangement of claim 1, wherein a portion of first layer or second layer is paper and shaped like a vase.

4. The three-dimensional flora paper arrangement of claim 1, wherein the first end of the biasing element is foldably coupled to the mid-section of the biasing element, and the second end of the biasing element is foldably coupled to the mid-section of the biasing element.

5. The three-dimensional flora paper arrangement of claim 1, wherein the mid-section of the biasing element is substantially circular in shape.

6. The three-dimensional flora paper arrangement of claim 1, wherein the first end and second end of the biasing element are substantially rectangular in shape.

7. The three-dimensional flora paper arrangement of claim 1 further comprising a third layer rotatably coupled to the first layer, wherein the third layer can be rotated relative to the first layer.

8. The three-dimensional flora paper arrangement of claim 7 wherein the first layer includes one or more slots, there third layer being coupled to the one or more slots and having a rotational range of motion limited by one or more dimensions of the one or more slots.

9. The three-dimensional flora paper arrangement of claim 1 further comprising a first fastener coupled to the first layer and a second fastener coupled to the second layer, the first fastener and second fastener being configured to selectively couple together.

10. The three-dimensional flora paper arrangement of claim 8 wherein the first layer includes a horizontal fold configured to allow an upper portion of the first layer to fold into a folded position adjacent to a lower portion of the first layer, and the first fastener is coupled to the upper portion of the first layer.

11. The three-dimensional flora paper arrangement of claim 1 wherein the biasing element includes an aperture configured to permit manipulation of the mid-section of the biasing element.

12. The three-dimensional flora paper arrangement of claim 1 further comprising a third layer coupled to and between the biasing element and the mid-section of the first layer and coupled to and between the biasing element and the mid-section of the second layer.

13. The three-dimensional flora paper arrangement of claim 1 wherein the third layer is a loop.

14. A method of biasing a flora paper arrangement into a three-dimensional display state comprising:
coupling a first layer with a first end, mid-section, and second end, to a second layer with a first end, mid-section, and second end, wherein the first end of the first layer is coupled to the first end of the second layer, and the second end of the first layer is coupled to the second end of the second layer; and
coupling a biasing element with a first end, foldable mid-section, and second end, to the first layer and second layer, wherein the first end of the biasing element is coupled to the mid-section of the first layer, and the second end of the biasing element is coupled to the mid-section of the second layer; and
biasing the foldable mid-section of the biasing element from a folded state to an unfolded state or from an unfolded state to a folded state.

15. The method of claim 14 wherein the mid-section of the biasing element is foldably coupled to the first end of the biasing element and is foldably coupled to the second end of the biasing element.

16. The method of claim 15 wherein biasing the foldable mid-section of the biasing element from an unfolded state to a folded state includes increasing a first angle between the mid-section and the first end of the biasing element, increasing a second angle between the mid-section and the second end of the biasing element, and increasing a third angle between a first portion of the mid-section and a second portion of the mid-section, wherein the third angle is approximately twice the first angle, and the first angle is approximately equal to the second angle.

17. The method of claim 14 further comprising:
coupling a first fastener to a second fastener, the first fastener coupled to the first layer and the second fastener coupled to the second layer.

18. The method of claim 17 wherein the first layer includes a horizontal fold configured to allow an upper portion of the first layer to fold from a folded position adjacent to a lower portion of the first layer to an unfolded position, and the first fastener is coupled to the upper portion of the first layer, and the method further comprises:
unfolding the first layer prior to coupling the first fastener to the second fastener.

19. A flora paper arrangement having a first state and a second state, the arrangement comprising:
a base having a first section and a second section;
an upper portion coupled to the base;
a biasing element having a fold configured to allow the biasing element to fold between the first state and the second state, a first end of the biasing element being coupled to a first central portion of the first section and a second end of the biasing element being coupled to a second central portion of the second section, the fold being situated orthogonal to a line between the first central portion and the second central portion.

20. The flora paper arrangement of claim 19 wherein the first state is a folded state that is substantially flat, and the second state if an unfolded state that is substantially three-dimensional.

21. The flora paper arrangement of claim 19 wherein the arrangement is made of one or more types of paper product and the upper portion is configured to resemble a flower arrangement.

22. The flora paper arrangement of claim 19 wherein the biasing element has a first rectangular portion coupled to the first section of the base, a second rectangular portion coupled to the second section of the base, and a circular portion coupled between the first rectangular portion and the second rectangular portion, the fold being located on the circular portion.

23. The flora paper arrangement of claim 19 wherein the upper portion includes one or more rotatably coupled elements configured to rotate with respect to one another.
